(19) United States
(12) Patent Application Publication
(10) Pub. No.: US 2014/0120516 A1
(43) Pub. Date: May 1, 2014

(54) Methods and Systems for Creating, Delivering, Using, and Leveraging Integrated Teaching and Learning

(71) Applicant: Edwiser, Inc., Mendham, NJ (US)

(72) Inventors: Mung Chiang, Princeton, NJ (US); Sangtae Ha, Princeton, NJ (US); Stefan Rudiger Rill, Augsburg (DE); Christopher G. Brinton, Berkeley Heights, NJ (US); William Ju, Mendham, NJ (US)

(21) Appl. No.: 14/063,289

(22) Filed: Oct. 25, 2013

Related U.S. Application Data
(60) Provisional application No. 61/719,312, filed on Oct. 26, 2012.

(51) Int. Cl. G09B 5/02

(52) U.S. Cl. CPC G09B 5/02
USPC 434/362

(57) ABSTRACT

The present invention is directed to methods and systems that redefine how a course is taught and how material is learned in a large-scale class environment. In this system, there is adaptation of content presentation for each student, based on the tracking, learning, and profiling of student learning efficiency. Furthermore, the textbook of the present invention can be created during the delivery of course content, and sold at a variety of granularity.

This application claims priority to U.S. Provisional Patent No. 61/719,312, filed Oct. 26, 2012, and is incorporated herein by reference.

The present invention is directed to a comprehensive replacement for a traditional one-size-fits-all course and associated textbook, which improves upon teaching and learning. In other words, the present invention is directed towards personalized learning. The replacement textbook of the present invention preferably is delivered in a paperless fashion, is viewable on a device such as a computer or a tablet computer by a student, is individualized to a student's topical proficiencies and methods of learning, and includes means for proficiency testing. The present invention is applicable to various types of courses, such as high school, college, tutoring, professional exam preparation, corporate training, and specialized courses (such as preparation for a college entrance exam).

### BACKGROUND OF THE PRESENT INVENTION

The common approach in teaching a course such as in high school or college involves a teacher's reliance on a particular textbook. In this approach, an author prepares a textbook, published by a publisher, printed on paper, and distributed for sale to students and teachers. Teachers prepare a syllabus, including lessons. Teachers teach using the textbook as an aid, selecting portions to use in various lessons. Teachers then prepare examination materials and students take exams, which are generally graded manually by a teacher (or assistant). This process is labor intensive and may require mid-stream customization based on a student's success at absorbing and retaining the materials.

Also, the methods of learning using textbooks have not changed considerably for decades. In general, teachers teach by lecture supplemented with textbook as a primary tool, it is well understood that this process does not work best for all students in part because of the variability in learning among students.

In addition, the processes of generating and distributing textbooks have remained largely unchanged over the years, which have resulted in less than now-efficient processes. Over time, these costs and the associated logistical difficulties have grown.

As a result, it would be beneficial to have a solution which overcomes the aforementioned limitations.

Authoring a Textbook

The processes of developing a textbook often starts with an author writing a manuscript. Although tools for manuscript preparation may exist for textbook authors, the tools are directed to developing the type of single layout textbook that has existed for generations. The author typically prepares a manuscript and then iterates with the publisher using the layout tools, including potentially revamping the overall structure. Often, the textbook is intended to be applicable to a variety of levels of instruction and multiple course types and/or sections so as to increase possible sales. The layout is based on a combination of what the author and publisher conclude is best for the overall target populations of teachers and students. As a result, the layout and structure, while perhaps optimal from the perspective of the author and publisher needs, are less than optimal when it comes to any particular class or any particular student. Because students learn in different ways, it would be helpful to have tools for laying out, structuring, presenting and utilizing a course that benefit students of a wide range of abilities and strengths, accommodating the different strengths of individual students, and aiding students in overcoming learning inefficiencies. By extension, it would be helpful for an author to have a tool which may allow for ready customizing course-by-course and student-by-student.

Also, authoring tools available today are quite limited, such as with respect to layout guides. Authors currently use traditional layout guides to format content—including text and images. Typically the layout is likely to be most conducive to the broadest possible audience, from at least the perspective of the author, but cannot be advantageous to all students. There is no authoring tool directed to making the content and presentation most conducive to an individual student, such as including multiple variations of similar content or material, described in different media formats. It would be beneficial to have an authoring tool whereby an author could customize the delivery of content in such a way that each student would receive an individualized learning experience aligned with that student's needs.

Teaching a Course with a Textbook

Although at, times a teacher might supplement the textbook with additional materials, the book itself is changed only infrequently and typically only from edition to edition. Because of the start-up costs associated with preparing new editions of textbooks, such updates happen infrequently. The infrequency of updates of textbooks, however, results in slow implementation of changes.

Also, the same textbook is often intended to be applicable to multiple sections (accelerated, remedial, etc.) of the same course. Consequently, it is often the case that a particular textbook must be filtered by a teacher for use in the course section being taught by selecting only portions of the textbook for study and, at times, supplementing the textbook with extrinsic materials. As a result, different teachers and different course sections utilize or require different portions of the textbook, despite the content of the textbook being fixed. Because the basic content is fixed, it is left to the teacher to adjust the use of the book to each section of the course. And even within a single class, there often exists diversity in prerequisites, requiring some students to receive additional review which is not necessary for others. Each of these factors results in duplicity of effort from teacher to teacher and results in non-uniform use from course to course and section to section. Also, in general, a textbook does not contain different plans of study for different sections or for types of students and it is left to the teacher to select portions of the textbook and, perhaps, supplement the textbook material. It would be beneficial to develop tools for creating and using an all-encompassing and customizable course-by-course and section-by-section flow for a textbook, which can be structured so as to be usable for different levels of instruction in an automated, fine-granular, and per-student-individualized way.

Further, in the present environment, a teacher can only customize the use of a book but cannot customize the content of the book itself. In effect, a textbook currently is a one-size-fit-all book, needlessly wasting paper and resources and, perhaps, not including some material a teacher might believe to be beneficial to include. That is, the teacher can inform students of which pages or sections are pertinent, and provide supplemental material to the course of study, but cannot modify the book itself. This filtering process results in at least some of the textbook being printed unnecessarily and also causes the teacher to act as a secondary author by extracting and supplementing the content of the textbook. Again, having an authoring process which results in a digital presentation of content that is better customizable to teacher and to student needs is desirable.

Beyond Merely Text and Images

Also, it would be beneficial to transform the textbook into a format for presentation on a multimedia device, incorporating more than text and images in a defined layout. This environment can also include audio and video files as well as interactivity for students, such as by allowing for common communication among students. As students communicate, it would be beneficial to allow authors and teacher to also supplement materials based on the communication. Further, it is desirable to have a tool which allows an author to develop for course delivery in such an environment.

It would also be beneficial to permit students to interact with the material, such as annotating, and this interaction might also be visible to other students. Similarly, because students can also learn from other students, it would be beneficial for students to interact with other students—either in real time or otherwise—on topical materials.

Electronic Books

More recently, e-books have appeared, eliminating paper costs and some logistics issues. Although these e-books are typically viewable on different platforms, such as computers and different tablet computers, they largely replicate textbooks in that they are generally electronic versions of the text, with simple processing features such as search and find and bookmarking. Even more sophisticated e-books that have touch screens enabling interactive gestures by the reader are still fundamentally a conversion of a hardcopy book into an electronic file of the book, albeit with an improved user-interface.

In actuality, paper books may have one advantage over e-books—the ability of a student to personally annotate and highlight. However, books that are annotated and/or highlighted by students may preclude their reuse. It would be beneficial to have processes which leverage these benefits as well as the e-book benefits.

The present invention is directed in part to digital course delivery, which is useful to enable a number of other features. A prime example is the creation of a collaborative workspace, to replicate student-to-student and instructor-to-student interactions. This can be accomplished by including forums for discussion among students and others as they progress through the course, accessible from within the platform itself. Here, students and instructors can post and answer questions or seed relevant discussions. Further, as social ties are created, students could choose to interact outside of the forums by sharing their private highlighting, annotations, and notes with one another.

In the context of the present invention, an e-book, and not a paper book, is progressively delivered to a device and displayed to a student. Further, the e-book of the present invention intelligently adapts the content seen from student to student based on learning analytics that are trained in real-time. In some cases of e-books, additional content, such as videos, are introduced in the display, where the content is provided by the author or publisher. However, even when video is included in an e-book, the video is initially selected by the author, not the teacher or student, and may, at most, be selected for viewing by the student when the video (or a link to it) is made available to the student, but is not otherwise viewable or customizable. Further, the student typically has no control over text or video placement on the page.

Teaching

Teachers ordinarily use a textbook as a significant tool in teaching a section of a course. Ordinarily, a teacher lectures to an in-class collection of students, where the lecture and textbook can be used together in teaching the course. Although in at least some cases, all students in a section may have somewhat similar abilities, in other cases, student abilities and learning skills vary. The burden remains on the teacher to assure that each student—despite differences in student abilities, skills, and ways of learning—learns the material using the same lectures and textbook.

Also, because of the present in-class structure of teaching, classes are of fixed duration and teachers need to prepare lessons which encompass the fixed duration, such as an hour. Some topics can be taught in shorter time frames and some need longer time frames. As a result, class time is less than efficiently allocated. It would be beneficial to allow for lessons to be taught at times when the students can each be available to learn, and the lecture time can be adjusted to meet both the content need and the student's speed of learning.

With regard to teaching a “live” course, a teacher can supplement a textbook with additional types of materials, such as videos or technical papers. Teachers may from time-to-time, adjust lectures and supplemental materials, such as when the teacher is assigned to teach a section of the same course new for him or her. In some situations, a teacher may provide different materials to different students, though doing so for an entire class may be overly burdensome. Even so, as with the textbook, a teacher cannot readily “customize” to each particular student's needs very effectively.

Whether a teacher uses an e-book or a paper book, in the typical teaching environment a teacher teaches to the entire class and, because of the quantity of students in a class and the available time, not to individual student strengths. At times, a tutor may be employed to provide one-on-one teaching to individual students. In this scenario, a tutor typically identifies a student's learning strengths and weaknesses and assists the student by conforming teaching to the student's learning strengths. A tool for individualized teaching and learning, similar to a tutor's interaction with a student except which can be applied at large scale, is therefore desirable as well.

Wide-Scale Course Delivery

The problem of catering a course to each student's desires and needs is exacerbated when considering the recent explosion of Massive Open Online Courses (MOOCs), where enrollment can exceed tens of thousands and completion rates hover around one percent. Here, even selecting a few dozen students at random would have a higher variation in prerequisites and expectations than in a traditional classroom. On top of this, the teacher-to-student ratios in these courses are extremely low, with teaching staffs consisting of only a few experts. For these reasons, current MOOCs cannot possibly cater to the massive volume of students. Even in traditional course, for any particular section the teacher must identify topical areas, prepare lesson plans, and develop lectures. The topical areas are often provided in some form of syllabus to the teacher, and the lesson plans and lectures are often section-specific and adjusted by the teacher based on the teacher's perceived comprehension and interest of the students. Much of this developed material is replicated by other teachers in other schools. Also, teachers who teach the same course year after year personally repeat lectures. It would be beneficial to provide teachers with a tool whereby the lesson plans and associated content can be pre-selected based on the teacher's understanding of the student abilities and interests, so that a teacher's time can be spend working more closely with individual, students.

In any learning modality, having fewer students per instructor makes it easier for one human being to focus on the needs of each student individually and aids in alleviating issues with diversity in educational backgrounds. The concept of individualized learning in the present invention relies on artificial intelligence to create “virtual tutors” for personalized instruction, thereby scaling up the process. In the present invention, each particular course includes different learning paths that a student can traverse, which is analogous to having a separate virtual tutor for the homogeneous group of students using each path. A larger number of paths implies a smaller number of students for each tutor, thereby making the personalization more effective. As a useful analogy, the movement from one-size-fits-all to individualization is like developing a shoe which—rather than being a single, fixed size—can grow and shrink to fit the size of each of our feet. When core material does not change from year to year, the lectures can be recorded and included in the delivery platform for playback. This would improve teacher and student efficiency by allowing students to view the lecture at a convenient time for them—not necessarily at the same time for all students—and in combination with other related materials. Further, the materials can be synched to the lecture, such as when a teacher describes how to solve a math equation, a parallel display can show the steps as the teacher explains them. Subsequently, teacher can better utilize time by making him or herself available for more individualized assistance.

In summary, it would be beneficial to have a single source of content, where the content includes teacher lectures and other supplemental course material presented at various levels of complexity, enabling artificial intelligence to provide an individualized course delivery experience to each student. This enhances efficacy in massively scalable teaching.

Student Use

Although students may be able to peruse e-books, such as by the equivalent of page turning, the content of the book and, by extension the content of the display, tends to remain unchanged from student to student (“static” displays). These static displays mimic present paper-based books by generally being limited to text and images, and the positioning of content is “fixed”. Such fixed displays have limitations and are not the preferred display for teaching purposes for several reasons. First, the content available for viewing is limited to what the textbook author has determined to be the best available at the time of publishing and does not account for new content that might become available subsequent to the printing of the textbook. That new content may be related to and enhance the original content. Also, different students learn in different ways, and a fixed display precludes personalization based on student preferences or needs. In addition, the fixed displays are ordinarily limited to providing students with material to master, but are not directed to determining if the material has been mastered. When students want or need additional materials to supplement a given lecture, fixed displays place the burden of finding and displaying that additional learning material on the student. In addition, if a student is not proficient in a particular topic, there is no vehicle for a student to improve their own learning because of the fixed nature of the material. Such a problem is a big challenge to a student in that the student needs to identify the material. This is a particularly difficult problem for students to solve in that they do not have mastery of the material and may find it difficult to even identify the proper and relevant material. It would be beneficial for a textbook, particularly an e-book, to have materials available and accessible to a student to allow the student to rapidly access appropriate and related supplemental materials. Personalized instruction can help organize and present this material in the best manner for each student.

For instance, consider a college course (or MOOC) on the topic of Calculus. Such a course requires the student to have applicable foundations in Algebra. Geometry, and Trigonometry. Rather than the student needing to purchase a book to review the content, it would be better to have the content available in its entirety as a single source, with preferred content presented to the student and other content presented on demand or as needed. After all, sometimes students are unaware of the specific prerequisites they lack.

Another limitation in present textbooks and e-books is testing of students. Typically testing, and even interim testing, does not lead directly to follow up materials to aid students in deficiencies or determine if a student might accelerate. Teachers need to analyze testing result, provide supplemental materials based on those results, and rely on student mastery of the subject matter. It would be beneficial to have an automated testing process, which might vary from student to student, to determine student proficiency, particularly on a concept by concept basis. Further, it would be beneficial to have an environment whereby a student can follow up on such determination of proficiency with additional descriptive material and follow on testing when the student has been determined to not be proficient. That is, a student would progress in a course only upon mastery of material, not based on the schedule of the class.

It would also be beneficial to have an integrated textbook in which more than text and images were included and in which both the content and the display were customized to the student. For example, such an integrated book need not be used in combination with a teacher's lectures, but the teacher's lectures could be a part of the textbook. Similarly, notes and other annotations from students could be included in the integrated textbook.

Further, the present invention includes discussion forums, where a student can post, comment, or up/down vote each other's statements. In the context of the present invention, these forums are embedded in each section. Also, notes and annotations can be synchronized with currently available or other social media platforms, such as but not limited to Facebook, Twitter, and LinkedIn, so that students can share course notes with their “friends” if they desire.

As a result, it would be beneficial to have an integrated development environment whereby authors can layout and structure a textbook which can readily be supplemented by additional content from teachers. Further, it would be beneficial to have the display of such content be available across a plurality of platforms and be customizable based on student needs and/or strengths. It would also be beneficial to have such a development environment include automated testing to determine student comprehension and/or understanding, and allow for student input to the process of learning, such as through commenting for others. It would also be beneficial for such an environment to allow for adjustment based on the determined comprehension and understanding so that a particular student can accelerate or decelerate through a course as appropriate. It would also be beneficial for the student to self-customize based on the student's interests and strengths such as through annotation and highlighting. It would also be beneficial for other students to see such annotations to see what other students find most meaningful.

Similarly, it would be beneficial to make the textbook dynamic in that content can be added by teachers and students and such content can take a variety of forms. By allowing such dynamic adjustment, the content might remain current and be more comprehensive than presently available.

### BRIEF DESCRIPTION OF THE INVENTION

The present invention is directed to a development environment and set of tools for the creation, storage, updating, customization, as well as the use of an electronic book (“e-book”), which serve to overcome limitations of traditional textbooks, e-books, traditional teaching, and learning approaches, where the e-book of the present invention may be used to replace or supplement traditional lecture-plus-textbook courses. Today, the boundary between books and courses, and between publishing and teaching, is rapidly disappearing: books today are published in a variety of formats, including print, audio, and electronic, and digital textbooks continue to revolutionize as they begin to incorporate multimedia content. In the context of the present invention, these boundaries are entirely removed; as such, the terms “book” and “course” are interchangeable as they pertain to the invention, and unless otherwise noted, referring to the electronic delivery of an entire course experience with all relevant materials. At the same time, a “student” or a “user”, unless otherwise noted, refers to a consumer of any of the following programs/institutions: school, college, post-graduate, professional, corporate training, tutoring, compliance, certification, test preparation, and others as related. Additionally, an “author” refers to the producer of the course or book content, as used in any of the above scenarios, and a “teacher” to the administrator, instructor, and/or staff of the course (if applicable).

The present invention includes a processor-based development and storage environment. An author or another user may use the development environment and tools to create and update the e-book of the present invention. A user, such as a student or a teacher, may display the developed and stored content using an application or web interface for a computing device, such as a personal computer or tablet computer, where said application or web interface may be a part of the present invention. Student displays are individualized to that student and may be delivered using an application or a web interface for a computing platform specifically directed to student use. The application or web interface further includes means for authors, teachers, and students to provide additional content for storage, and to customize course material and presentation.

The present invention is further directed to removing any boundary between textbooks and an open online course delivery environment. The present invention, referred to as a Mobile Integrated and Individualized Course (“MIIC”), integrates text, images, audio, video lectures, quizzes, discussion forum threads, class wiki, blogs, note taking, social media; including but not limited to Wikipedia, Facebook, and Twitter; bookmarks, other social learning environments, and other online communication and content sources into a single mobile app (or web interface), and presents the combination in an algorithmically-applied, individualized, and logical sequence and in a particular display so as to conform to the student's learning ability in a most beneficial way. The MIIC may include a plurality of discrete lessons for the course, where each lesson may have several different units of aggregated content, and where each unit may be directed to different students or students with different needs. The MIIC may also integrate other content, such as animations, 3D models, interactive graphics, embedded websites, links, tables, and other forms of content as well. The algorithms are based on a combination of student usage data collected as a part of the present invention, student preferences, and beneficial learning approaches of similarly situated students. The MIIC is both personalized to the student and integrates a variety of materials.

The MIIC of the present invention includes a library of content (the “MIIC library”) for a course and a sequence of how at least since the content is presented to a particular student. That is, one may think of the MIIC as the combination of a textbook, lectures, and related materials, delivered in a customized fashion to a student. In general, a MIIC varies from student to student despite the MIIC library, representing all available course material, perhaps being the same for each student. The WIC also includes a development environment, a compiler, display tools, and a database of indexed terms for association between different materials. The MIIC further includes processor functionality to implement algorithms for determining which content should be displayed to a particular student, the sequence and layout of displays, and means for determining student proficiency, which may be customized for each student.

For example, if the MIIC is directed to a U.S. History course, the MIIC library would include content directed towards, among other topics, the U.S. Civil War, the Great Depression, and the moon landing. The content would or could include video from the time periods, reenactment videos, textual descriptions, images, audio lectures, audio clips, news articles, and commentary from students. Some content would be displayed for different lessons, and other content could be displayed for reinforcement or remedial help. But, using the processing capability of the MUG, the specific content regarding each of the topics would be displayed to a particular student in a sequence best conducive to that student's learning and proven proficiencies. Proficiency testing in each topic might be based on that student's results from prior topics. The result of proficiency testing can result in additional content on that subject being displayed to the student, with the specific material tailored based on the proficiency results. The student can supplement the material with other available materials as well.

### BRIEF DESCRIPTION OF THE FIGURES

FIG. 1 depicts an example schematic diagram showing how authors, teachers, and students aggregate content and how the content is used relative to lessons.

FIG. 2 depicts the relationship between the library of the present invention and various tools of the present invention which can be used for populating content in lessons and sublessons.

FIG. 3 depicts the relationship between a computing device of the present invention and a server of the present invention which together communicate using a network and input and output devices.

FIG. 3A depicts a flow chart of one specific aspect of the server shown in FIG. 3.

FIG. 4 depicts a flow chart of how content might be determined for display to a particular student.

FIG. 5 depicts the relationship between various stored data which are used to determine presentation of content to a student.

FIG. 6 provides an alternate depiction of how content is displayed for a particular student.

FIG. 7 depicts a state matrix showing possible ways a student might progress in a course in the context of the present invention.

FIG. 8 depicts a schematic of the relationship between a student's display and the server and library of the present invention.

FIG. 9 depicts an example screen which a student would see on the students device.

FIG. 10 depicts the typical display for one portion of a lecture on elementary Algebra.

FIG. 11 depicts the typical display for one portion of a lecture on Linear Algebra.

FIG. 12 depicts a simplified state matrix showing an example of possible ways a student might progress in a course in the context of the present invention.

FIG. 13 depicts a sample flow with breakdown of modules and corresponding assessments.

FIG. 14 depicts a model of how proficiency determination with respect to testing and quizzing could be implemented.

FIG. 14A depicts a flow chart of the relationship between user interaction and content presentation.

FIG. 15 depicts one example of a flow chart for content addition using social media.

FIG. 16 depicts another example of a flow chart for content addition using social media.

### DETAILED DESCRIPTION OF THE INVENTION

The MIIC of the present invention is readable in a plurality of electronic formats, leverages a variety of electronic resources, allows for multi-media presentation on a variety of possible presentation platforms, and is usable by instructors and students for the purpose of teaching a particular section of a particular course. The systems and methods of the present invention enable publishers and authors to sell books, and teachers to host courses, through web portals, or applications on computers, tablets, is phones, and other consumer electronic devices, and to provide Integrated and Individualized learning experiences to students.

Furthermore, the present invention includes methods and systems whereby content is introduced into and later extracted from a library, and is adapted in real time for presentation to each individual student, where the adaptation is based in part on data collected through tracking student actions and desires, learning student behavioral preferences, student proficiency, and profiling student learning efficiency. The tracked data are used algorithmically to customize subsequent displays, and the algorithms use student proficiency and other data to determine content and method of presentation. To facilitate this aspect of the invention, students will need to register and authenticate before using the present invention. The tracking data may relate to a particular student or to students in general, such as similarly situated students. The collection, processing, and usage of such data are embedded in the e-book platform of the present invention and can be split across different storage and computing devices.

For example, the font size, color, presentation order, or the collapse or expansion of certain parts of a book can be adapted to each student's learning efficiency, to individualized to each student and further adapted over time. Most importantly, the actual content and sections delivered to a student may differ from student to student. No two books or courses are necessarily the same. Each student witnesses his or her own version of a parallel universe.

Furthermore, the present invention allows for overcoming the issues related to a stagnant book, such as existing books, by customizing delivery of course content, for example, by transcribing video content by allowing authors and instructors to add or change existing content, and by crowdsourcing book writing, particularly supplemental material, to any number of students. In an online course of durations ranging from a single lecture to a whole semester or year, the video, test material, and other content can be included in the library at the start, and as the course is offered over time, additional content can be generated and the library continuously updated in part based on newly available content and social learning on platforms such as discussion forums.

The textbook of the present invention further includes built-in, author-specified testing for student proficiency and algorithmically determining how lessons for that student should progress.

The MIIC of the present invention includes content originating from various sources and in various media forms, and the content displayed to a student is customized based on the lesson of display and the student's needs and interests. In addition to initially determining the student's needs and interests algorithmically, in the context of the present invention the student can further control the content displayed by indicating the need for more detailed or differently displayed content. Content can also be adjusted based on results of proficiency testing.

In summary, the e-book of the present invention is customized for each student, comprehensively includes all requisite materials to assure student proficiency, provides testing to assure student proficiency, and provides a means to allow a student to take a course at convenient times and to progress at a rate and with content displayed most conducive to each student developing proficiency in the topical areas.

Publishing Platform

The present invention also includes a publishing platform for an e-book, allowing an author to create one from scratch. The publishing platform is comprised of an authoring tool, to allow an author to construct a nominal presentation layout, create assessment questions, import a library of content—where the library may include text, images, audio, and video—and define the logic that dictates which pieces of the library will be presented at a given point. The authoring tool also includes templates and resources for tagging content with learning concepts for the course, as well as for entering content into the library, in the present invention, content is tagged and, in effect linked, within the library and in the nominal layout. For example, an author may choose to make some content visible only when a student wishes to drill down to better understand the material, or when the student's proficiency level on the respective concept is unsatisfactory. Additionally, the nominal presentation layout of the material could be customizable by a student. Preferred software embodiments of the authoring tool would be Windows, MAC OSX, and/or web platforms.

The publishing platform of the present invention also includes methods for processing and automatically converting pre-existing books and other materials into a format compatible with the textbook of the present invention. The platform includes a WIC compiler, which is used to determine content, sequencing, and associating with other content. The compiler tags headlines, paragraphs, images and other forms of organization of the content by assigning a unique identifier and converting a digital book into a file format usable by the tools of the present invention. Such tagging may be used in the present invention for indexing and associating content with other content, thereby forming a “map” of how content may be presented (both sequence and display), for each of several lessons. Such a map, possibly in the form of a flow chart, may be made available to students. By having the aggregation of tagged content of various media types, an author (or in some cases a teacher) can select which content and in what sequence and in what combinations the content can be provided to students so as to assure adequate material is available for a student to become proficient, and the teacher can identify follow on content for further drill down as needed by students. The net result is development of content which may be applied to different lessons.

Further, the content included in the textbook of the present invention includes material for determining student proficiency and delivery of content may be sequenced under student direction (by presenting additional materials) based on the student proficiency. Determining proficiency is described in detail herein, but may be based on a combination of (a) performance assessment, in part on a sequence of testing, (b) correlations of assessment with human behavior, such as but not limited to video watching and text-reading, and (c) similarities to similarly situated students, such as those with similar academic foundations. At least some of the criteria might be customizable from student to student.

One goal of the present invention is to formulate an electronic “textbook” for use relative to a particular course (or portion of a course) such that the e-book may be used for the combination of content delivery, including lecture, and assurance of student comprehension. Such a book may be sold in aggregate or a subset may be sold, such as for a particular level of a particular course. The granularity of selling MIIC access, such as with an app or web client, can be based on chapters, lectures, sections, or any other unit of content.

The actual delivery of content in terms of specific items is customized and sequenced to best conform with the student's proficiencies and learning preferences. In effect, each book used for study becomes a portion of an open online education experience with an individualized “tutor” that is specifically directed to that student.

In the context of the present invention, students can concurrently view a video, such as a lecture, with additional text and/or images which add to the student's learning ability. Further, the layout of the screen can match the student's best viewing for learning.

Testing student proficiency is built into the MIIC as well through regular quizzes, exams, and other validation means so as to assure and/or determine that students have adequate comprehension of materials before progressing in a course. A teacher can opt to use the built-in testing, or may opt out of its use and choose to write new questions and to test separately.

Formulating the Initial MIIC

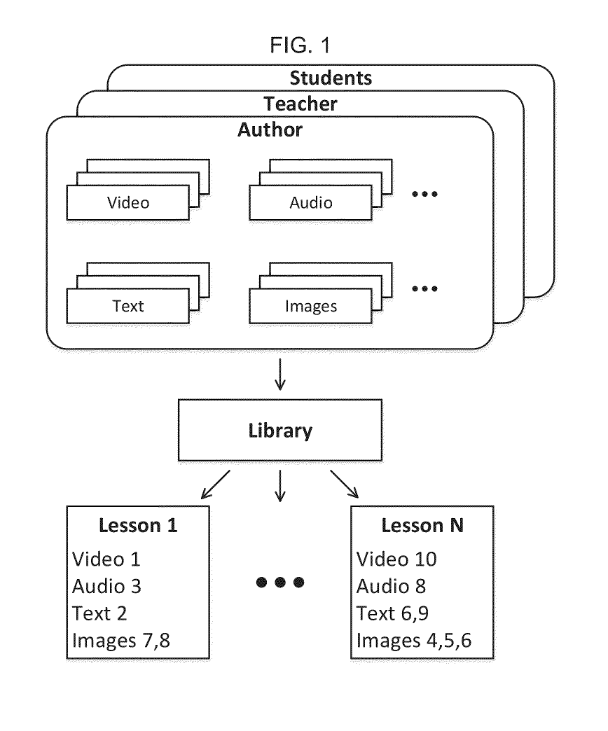

One aspect of the present invention involves a system and method for dynamic creation of a MIIC library and associated tools for its creation. FIG. 1 depicts a flow diagram for formation of a MIIC library. As can be seen in FIG. 1, a variety of types of content can be included in a MIIC library, including but not limited to text, video, audio, images, blog entries, and note taking, as well as means for assessing student proficiency. Importantly, and as can be seen in FIG. 1, while the initial source of such content is an “author”, subsequent sources include teachers and students.

In a preferred embodiment, a MIIC initially is prepared as a series of individual elements, which are akin to lessons. Each unit of content, no matter its form (text, image, etc.), is assigned a unique identifier once the author imports it into the library (using the authoring tool). The unique identifier is included in an index which may take the form of a database. The unique identifier, or tag, is then used to attribute online content to one or more specific elements of the book. That is, each tag is unique to an item of content and is used for associating aspects of the content, such as keywords and applicable lessons. This assignment of online content to elements can be performed by authors, publishers, teachers, or students in a public or private way, before or after the release of the MIIC. References to these assignments are stored in an online database, accessible to all computational devices to which an MIIC is accessible. Parts of the database are also cached on the devices if necessary.

The length of each element/lesson is determined by the content it contains, and the author can make these as coarsely or finely granular as desired. Online content may include, but is not limited to links, videos, wiki articles blog posts, forum posts, images, quizzes, Question & Answer (Q&A), other organized documents, and social media content, such as sourced from Facebook and Twitter. Later entries, such as new content provided by a teacher or new content in a blog entry, can be introduced to the MIIC as they are introduced in a course. As a result, the WIC can be viewed as an evolving set of content.

The result is that a multi-layout electronic textbook is prepared, where the textbook is inclusive of lecture materials.

Tagging

In order to identify content applicable to different portions of a course, the content is tagged in various ways at about the time the content is introduced into the library through the authoring tool. Each content unit may be used for different lessons or in different sequences for any particular course or section of a course. In addition, the book of the present invention is further customizable on a user by user basis to conform to a user's desired, historic, or algorithmically-determined preferences.

Each content term is tagged so that it is identifiable in various ways, such as but not limited to the type of content (video, text, etc.), keywords in the content, key concepts covered in the content, and applicable lessons and/or subject matter. Notably, the tagging of keywords and key concepts can be automated or manually performed, depending on the author's preference. Key terms can be extracted using known text and/or sound recognition techniques; alternatively, they can be identified by the author and publisher in advance, such as through the authoring tool. Key concepts can be discovered by charting users' performance and applying algorithmic techniques to construct a low-dimensional model for the course features that have the highest impact on grade variation; alternatively, the author can specify these features in advance.

Each element may be tagged in multiple ways, such as being tagged for a plurality of lessons as well as for the detailed applicability of student types (remedial, slow or fast learners, students with certain determined proficiencies, etc.). Each element may also be tagged as being associated with other elements.

Each piece of content is tagged in a particular fashion. This tagging is useful toward identifying particular information regarding that content, such as what topics it might relate to, its source, the type of content (text, video, etc.), the level of detail, and so on. This tagging allows each piece of content to be associated with other content and with one or more lessons as well. By tagging all content, teachers (and others) can rapidly identify its relevance to various topics and interests. Further, the tagging permits automatic structuring of content for display—that is, certain content can be displayed together and for example, images can be slotted in the appropriate point in text.

As stated, at least one portion of the tagging process may be automatic. With regard to text-based materials or materials which can be converted to text, in one embodiment of the present invention a piece of software scans through the whole document and marks every element that is of relevance to the teacher (or the author) with an universally unique identifier (UUID). In the authoring tool, the author (or teacher) is able to assign more or alternate data to that element, such as difficulty, keywords, etc. These additional identifiers are then stored in a database in relationship to the UUID, and can be stored in the document itself as clickable and indexed. So when a reader application analyses a document it can fetch the UUIDs and use them to communicate with the server on what should be done. When a user clicks on the word or image, additional related content may be delivered to that student. Similarly, such student clicks are tracked and used as a part of the proficiency determination process.

There are several alternatives for videos. The current approach is that when a video is imported through the authoring tool, it is assigned a UUID in an additional file (or in a database). Information like difficulty, keywords, time-content relationships and additional information is then also stored in the database in relation to the UUID. But many video file formats offer a store that can be used directly and can be read out by software. So the information could be stored in the video file in addition or in the alternative. Both options might be used based on the circumstances. For example, a thumbnail image of the video will most likely not end up in the video file's store but instead stay as a single file on the device or server. But then the video file's store will hold a path to that thumbnail.

When a teacher wishes to prepare a more specific lesson, the teacher can peruse the library by examining the tagging. A teacher's version of the app may facilitate such a service. In the context of the present invention, the tags are indexed and search functions allow for perusal of the index in various ways. Initially, an author identifies the various materials applicable to a course. These materials may start, for example, with a digital version of the content of portions of a textbook plus lectures (textual, image, video, or some combination), as well as proficiency determination materials. In total, these materials, as initially identified by an author, represent a library of materials for a course, which can in turn be augmented by the teacher for a specific instantiation.

Tools for Formulating a MIIC

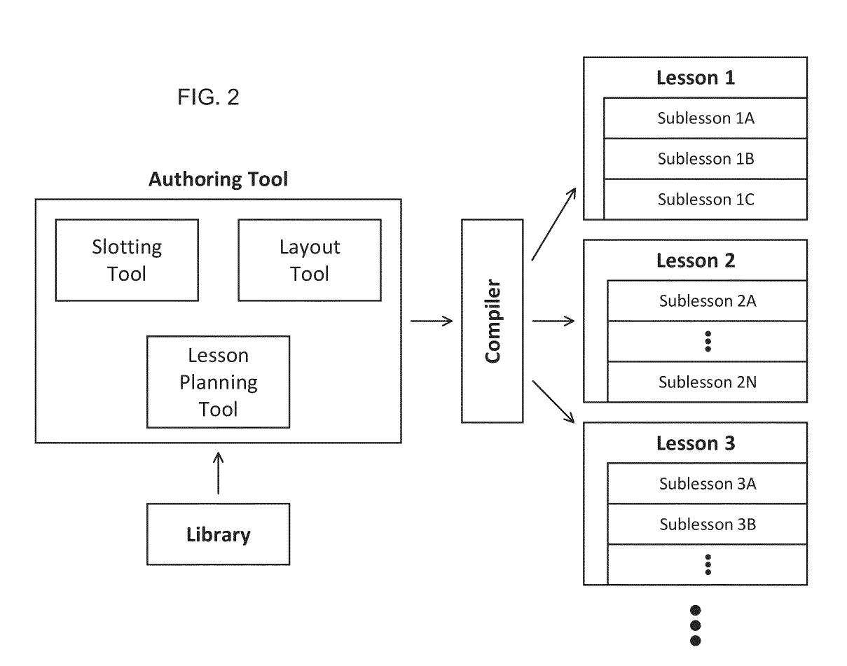

A set of tools, ultimately comprising the authoring tool, is available to authors to formulate a MIIC from the library of materials. FIG. 2 shows application of the set of tools. In the preferred embodiment, these tools include a graphical user interface presented to the author in a downloadable application or a web client or page. In the preferred embodiment, these tools remain resident on a server but may be downloadable to the author's platform as well.

As can be seen in FIG. 2, the authoring tool contains layout and slotting tools. These, along with others, form a development environment for an author, and interact with the library of the present invention by providing the author with access to stored content, much of which may have been stored by the author in a tagged environment. These tools further include means for an author to establish a lesson plan. The lesson plan may have any number of lessons. The lessons may be established serially that is, lesson 1 is followed by lesson 2, and so on.

Each lesson can be constructed in a number of ways, depending on the author's method of constructing learning paths. In a preferred embodiment, an author has prepared varying levels of difficulty for lessons, with each degree of difficulty reflecting the level of challenge for different student proficiency groups. That is, lesson 1 may have three different versions—one for accelerated students (referred here as lesson 1A), one for mid-range students (referred here as lesson 1B), and one for students needing additional materials (referred here as lesson 1C). Within each of these sublessons, material can be prepared for presentation in terms of initial material as well as several layers for drilling down by students. This drill down material may be organized generally or by narrower topic. Certainly, the same content may appear in multiple places. Note that the organization of content in this manner is done through the authoring tool, which provides the author with drag and drop functionality that allows him/her to visually separate the content from the library in this manner.

Each lesson may end with a quiz or some factor in proficiency determination and each course may end with a graded exam (or include intermediary graded exams as well). In the preferred embodiment, determinations are embedded in the library and particular selections of questions (a subset of all questions) can be chosen automatically using a variety of criteria, such as prior demonstrated proficiency or duration of material on a screen. Grading of these exams is preferably automatic as well; in the preferred embodiment, the authoring tool contains an, interface for creating multiple choice questions and assigning point values to be awarded for each answer choice. Like the lessons themselves, the quizzes may differ by sublesson or may be included in drill down areas. As a result, a multidimensional matrix of content can be prepared, where each entry of collection of content is referred to as a “box” of content. Once an author prepares an overall lesson plan and identifies initial content in each box, the WIC is ready for compilation. But even after it is compiled, the content may still be supplemented in various ways. For example, a particular teacher can introduce additional supplemental content for a box, such as a news article. Students can also provide additional content, such as by providing their own notes or highlighting. The content can be updated by authors, teachers, and students as well. As a result, a dynamic e-book for a course can be established. This enables authors to incorporate further feedback over a long timescale, and consistently update their courses; for instance, they can correct errors and keep the content up to date.

Further, once the course is established, lesson guides can also be included for each lesson, sublesson, or box. Such guides may be made available to subsets of users, such as only for teacher use.

Once the MIIC, including “internal” content, is initially published, the book may still be added to by teachers and students. Such external content, i.e. content not directly contained in the initial MIIC, allows the book to become a highly integrated and individualized form of education, inducing further and more detailed engagement in the reader.

The MIIC compiler of the present invention also includes the ability for an author to assign content to one or more appropriate boxes and for allowing for a variety of ways for displaying some or all of the content.

Architecture

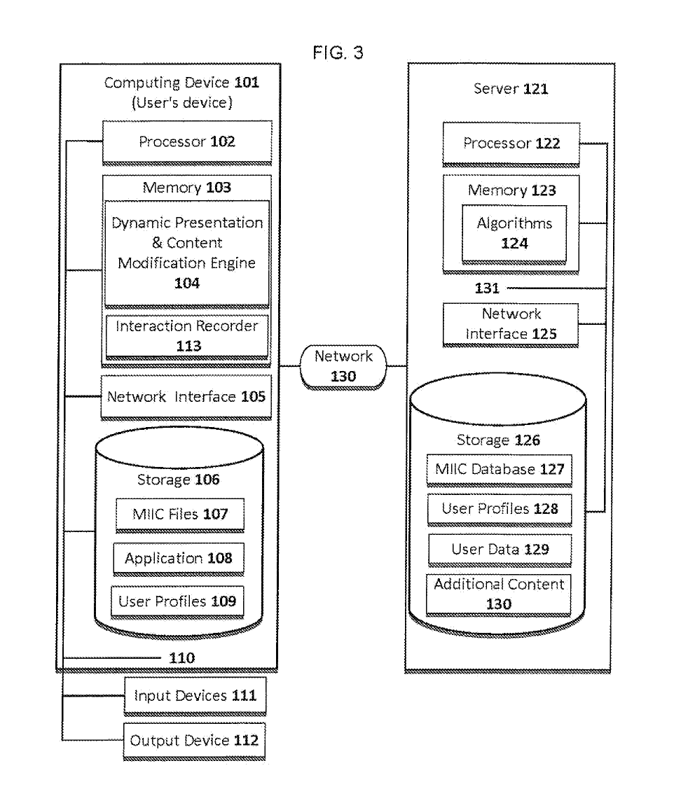

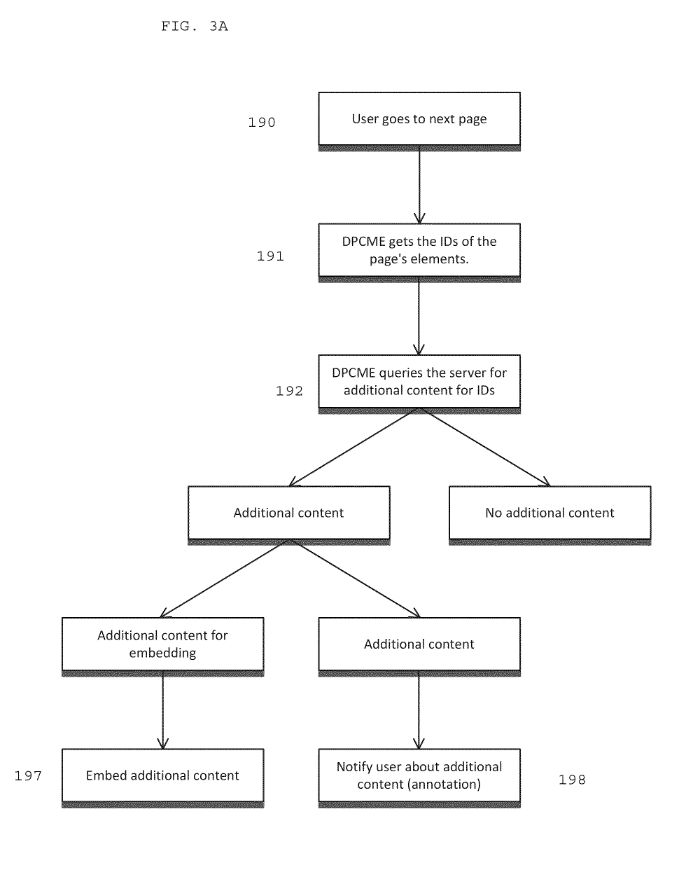

Architecturally, the present invention includes one or more servers, one or more data stores, and network connectivity for communication to user devices. FIG. 3 shows an example of the architecture of the MIIC of the present invention in which computing device 101 is used for the purpose of presentation and includes, among other elements, user profiles 109 and an engine for presentation 104. Computing Device 101 is in communication with Server 121, which retains data regarding content for each lesson and sublesson. Computing Device 101 also communicates with users through input devices 111 and output device 112.

The system includes a computing device 101, which acts as the client and is used by the user, preferably a modern tablet computer, and a user processor 102 or a network of servers. A network 130 connects the computing device 101 and the server(s) 121. In general, the network 130 may be a telecommunications network and/or a wide area network (WAN). The network 130 can be the Internet.

The computing device 101 includes a processor 102 connected via a bus 110 to memory 103, a network interface 105, storage 106, input devices 111 and an output device 112. The processor 102 can be any hardware processer used to perform an embodiment of the invention.

The computing device 101 is generally under the control of an operating system (not shown). Examples include Android, iOS, Microsoft Windows, MAC OS, UNIX and Linux. More generally, any operating system supporting the functions disclosed herein is compatible with the present invention.

The memory 103 is preferably RAM, large enough to hold the necessary programming and data structures of the invention. Memory 103 can comprise of multiple of modules and different levels, from high-speed registers to slower but larger DRAM. The memory 103 includes a dynamic presentation and content modification engine (DPCME) 104, which is then executed via the processor 102 and the results are rendered and forwarded to the output device 112. The memory 103 also includes the interaction recorder 113 which records and analyses the user's interaction with the device.

The network interface device 105 may be any entry/exit device configured to allow network communications between the computing device 101 and the server 121. It could be a network adapter or other network interface card.

The storage 106 may be a Direct Access Storage Device. Although the storage 106 is shown as a single entity, it may be a combination of fixed and/or removable storage devices, such as fixed hard or solid state drives (SSD), removable memory cards like MMC or SD and optical drives.

As shown, the storage 106 includes the MIIC file 107 as the local content provider, the application 108 itself and user profiles 109. The MIIC file's 107 content will be modified by the DPCME 104 and provided as output to the user.

Although embodiments are described herein with reference to the MIIC file 107 and user profiles 109 that are stored on the computing device 101, those skilled in the art will recognize that embodiments of the invention may be adapted for the MIIC file 107 and user profiles 109 that are stored elsewhere. For example, the MIIC file 107, user profiles 109 and additional content may be stored elsewhere, such as in the storage 126 of the server 121. That is, in some embodiments the computing device 101 may download MIIC files 107, user profiles 109 and additional content 130.

The input devices 111 may be any devices for providing input to the computing device 101. For example a touch-screen, keyboard, digitizer, camera or speech recognition unit and the like may be used.

The output device 112 may be any device for providing output to a user of the computing device 101. It might be any conventional display screen, a touch screen or a set of speakers along with their respective interface cards, i.e. video cards and sound cards (not shown). Although shown separately from the input device 111, the output device 112 may be combined with the input device 111. For example a display screen with an integrated touch-screen or speech recognition unit combined with a text to speech converter may be used.

The server 121 generally includes a processor 122, memory 123, network interface 125 and storage 126, coupled to one another by a bus 131.

The memory 123 is preferably RAM, large enough to hold the necessary programming and data structures of the invention. Memory 123 can comprise of multiple of modules and different levels, from high-speed registers to slower but larger DRAM. The memory 123 includes algorithms 124 that are analyzing the interaction data collected by the computing device 101 and which have been send to the server 121. The algorithms' results are then send back to the computational device 101 and stored in the user profiles 128 in the storage 126. In general, the algorithms include a collaborative component that leverages the data collected across all computing devices, though only one device is shown here.

The network interface device 125 may be any entry/exit device configured to allow network communications between the computing device 101 and the server 121. It could be a network adapter or other network interface card.

The storage 126 may be a Direct Access Storage Device. Although the storage 126 is shown as a single entity, it may be a combination of fixed and/or removable storage devices, such as fixed hard or solid state drives (SSD), removable memory cards like MMC or SD and optical drives. The storage 126 may include, but is not limited to
The MIIC database 127 containing the MIIC courses themselves as well as additional information about their content and properties.
User Profiles 128, which have been derived by analyzing user behavior, interaction, and learning patterns.
User Data 129, which includes but is not limited to account information, performance history, personal information a user has shared, the MIIC courses a user has purchased.
Additional Content 130, which is material that has been uploaded by teachers in their specific class instances.

The application itself consists of different parts:
A rendering engine, preferably based on WebKit (if more information is necessary: http://en.wikipedia.org/wiki/WebKit), which displays and interprets the different types of content mentioned before.
An implementation to record user interaction interpret it, and send it to the server 121 for further analysis.

The DPCME 104 interprets instructions for the content modifications. The algorithms, processed either on the computation device 101 or the server 121 (shown here as the latter), are generating these instructions. The DPCME 104 then creates further instructions for the rendering engine to modify the content.

The application 108 is capable of incorporating common e-Book reader features, as well as some that are unique to this WIC platform:
Different fonts and font sizes.
Pagination, as well as Page Forward and Page Backward.
Navigation to a specific page based on user input.
indexing.
Storing the current state of the application upon termination of the reader, and reloading this once the user reopens it.
Text search throughout the user's current learning path.
Highlighting text, storing the highlighting changes, and restoring them if necessary.
Support for previously listed content types: video, textbook, assessments, animations, and social features.
A user interface (UI) that interleaves the presentation of video, text, animations, and social features for course delivery.
Creating, storing, and applying bookmarks on both pages and video frames.
Creating and storing annotations and notes within a single view,
Login with social network credentials such as Facebook, Twitter, or LinkedIn, allowing users to share notes with their “friends”.
Text lookup on internet (e.g., Wikipedia) and intranet (e.g., personal course wiki) platforms, to be displayed on the web browser of the computing device.
Copy and paste for text and notes.
Dynamic table of contents which updates as the user traverses from lesson to lesson.
Text-To-Speech and/or speech-to-text conversion.
Digital Rights Management (DRM).

FIG. 3A depicts a flow chart of the use of the DPCME and how it might be applied to a user's use. As a user moves to a new page 190, the DPCME obtains the UUIDs necessary for the page's content 191 and obtains those pages or content for display. The DPCME also queries the server for additional content 192. If additional content is necessary and it needs to be embedded in the display, the content is embedded 197. If all that is necessary is to notify the user of the content, such notification is provided 198.

The application may incorporate further features that the user can use and interacted with. Generated data objects like bookmarks or annotations might be not only stored on the computation device 101 but also on the user processor 102 to enable data sharing between different devices.

Content Selection

Once each box's content is identified, the author can select a preferred approach to presenting the materials to a student. For example, an author might choose to concurrently present text and embedded images, or may choose to present a video with highlighted text alongside of it. Either way, this preferred set of content may later be overridden in part by a student's preferred selection of presentation.

Student Learning

In the preferred embodiment of the present invention, students view content is using an application on a tablet computer (“app”), although alternative display means are also available, such as a web client or a web page. As noted, content is displayed in the application itself. The form of presentation varies with the type of content. Possible forms include pop ups, overlays or completely new views displaying complete websites.

Students can override default displays with personal preferences. That is, if a student prefers certain backgrounds and layouts, those preferences can be used for display purposes.

Analysis of the user's reading behavior and interaction with external content is performed by algorithms and the results are used to optimize the layout and content as well as presentation and organization of external content. This ensures an educational experience, which is tailored to the reader's needs.

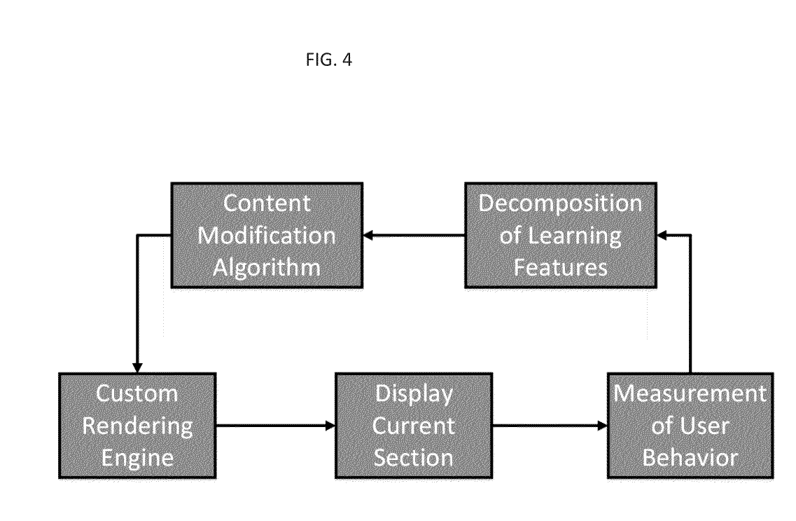

FIG. 4 depicts the approach of the present invention for displaying content. In the preferred embodiment, the present invention displays content for a particular lesson. The user's behavior associated with viewing that lesson is captured. This behavior could include, but is not limited to combinations of time viewing content, eye movement, note taking, etc. This set of measurement is then decomposed into the learning features, or key concepts, of the course that they are associated with: recall that the set of learning features are either specified by the author through the authoring tool, or determined algorithmically in which case they may or may not be concrete. Subsequently, the updated set of features, and the performance on each, is fed to a content modification algorithm which determines what to display next, and the custom rendering engine outputs the updated display to the user's screen.

The present invention also includes several mechanisms for determining student proficiency in particular course material. Once content is displayed to a student, the student's use of that material is tracked. In the preferred embodiment, tracking is done in a combination of ways. The duration of time that content is visible is tracked. The student's note taking as material is displayed is also tracked. The selection of drill down content is also tracked. Finally, student eye movement is also tracked in part to identify which of the displayed content is gaining the most attention. Together, these tracked data are used for two fundamental purposes—to improve content for lessons/sublessons/drill downs, and to determine areas where students need to spend “extra” time or less time, so as to determine student proficiency.

With regard to improving content, one approach of the present invention is to make collected data available to authors for lesson improvement over a longer feedback timescale. Alternatively, an algorithm may be applied for automated redistribution of content.

With regard to determining student proficiency, all student selection is tracked. As noted, quizzes can be made available to students as well. Quizzes may be customized based on the tracked data, prior quiz results, and student stated preferences. Between the quiz results and the content tracking, algorithms may be applied for identifying student proficiency and for directing the student to the most appropriate next lesson.

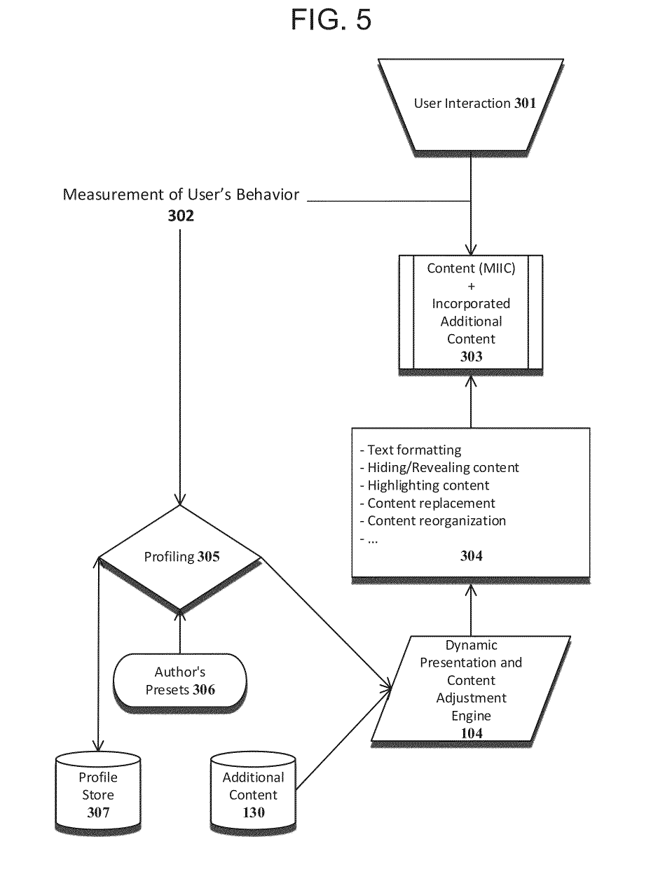

FIG. 5 depicts a flow chart for dynamically adjusting content. As can be seen in the left side of FIG. 5, a student's profile 305 is used as input to the presentation. A user's stored profile 307, in combination with an author's presets 306, modified based on the profile created regarding a particular user and other users, and with content obtained from the MIIC are presented to a student. Importantly, the presentation engine 104 adapts originally determined content, and adjusts that content based on profiling and other changes (such as adjustments made more generally by authors and/or the teacher).

Also, the profiles may be adjusted based on student proficiency determination.

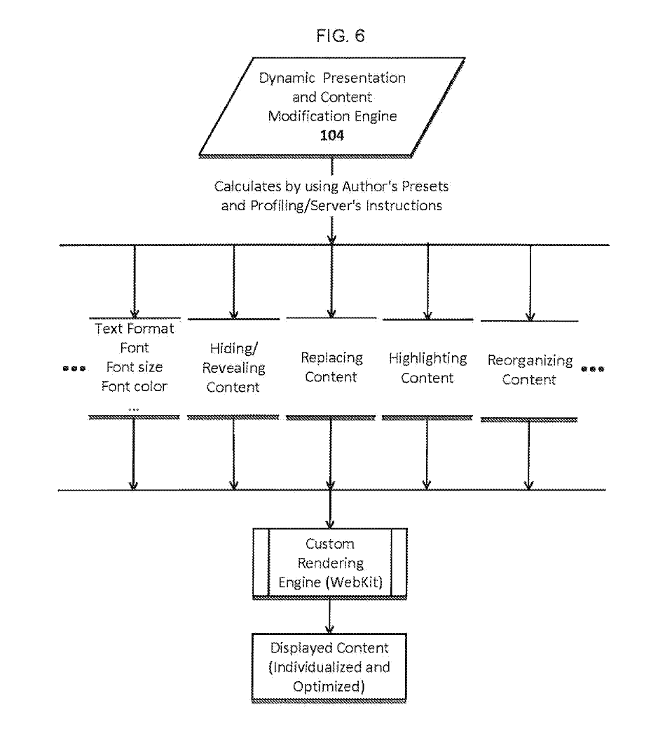

FIG. 6 provides more detail regarding how content is adjusted for display.

Among the attributes potentially being adjusted in real time are overall appearance such as text size and highlighting. These are adjusted based primarily on user preferences. Content can also be reorganized, such as by automatic determination of student preferences. Similarly, content may be replaced based on factors previously described. These various attributes are used to adjust content and the proposed content and display parameters are delivered to a custom rendering engine for display. In the preferred embodiment, WebKit is customized for use.

Assigned online content is also marked in the MIIC by bookmark—like symbols or highlighting portions of the book. These markers are, if necessary, updated with information from the online database whenever the reader views the relevant parts of the digital book.

New editions of MIIC may be released from time to time. When a new edition of an MIIC is released, tagging and therefore relationships to external content are transferred to the new edition if appropriate. For that purpose, algorithms analyze the old and new editions of the MIIC and determine different, new, similar and equal content. Content, which is equal or similar, is assigned the same tags as in the older edition.

As multiple MIICs are purchased by a single person, these MIICs can start interacting with each other. For example, some may merge into a single, hybrid WIC with access to a larger library of material. Additionally, jumping across multiple Miles becomes feasible.

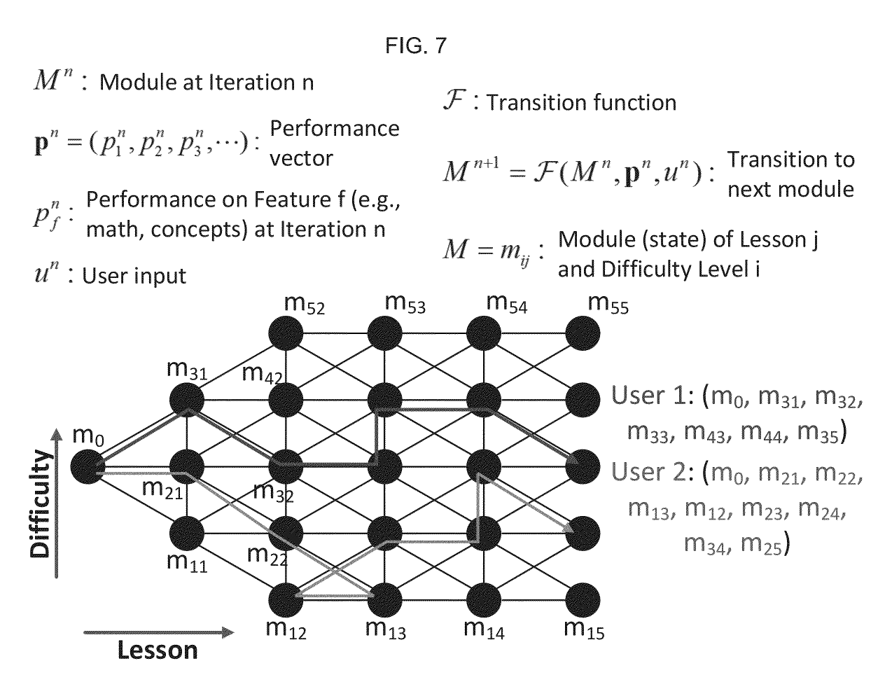

In addition, the present invention lends itself to interactivity between the student and the app as well as between a student and the student's teacher. For example, in an algebra class, a student can be given an equation to solve. The student may solve the problem on-line one step at a time and receive feedback on each step. Also, the present invention permits the teacher to observe the student's problem solving in real time. Through known features such as chat and control of a writing area, a teacher can give individualized, real-time feedback to a student as the student solves the equation. FIG. 7 shows one preferred embodiment of how a student might progress through a course in the context of the MIIC of the present invention. Shown is a simple state matrix as an example, with each state shown as a circle and defined as a module, which is a particular instance of a lesson. This state matrix is constructed by the author through the authoring tool, with content allocated to each circle using drag and drop functionality. A student begins at Module M₀ and attempts to work his/her way to the right (per the example of FIG. 7); note that if prior history is incorporated, there can be multiple starting states as well (not shown here). Each column j represents a particular topical lesson and completion of the course requires, at a minimum, completion of at least one module per column. For example, if the course is early twentieth century fiction, Sᵢ₁ may represent literature of the time period from 1900-1910, Sᵢ₂ may represent literature of the time period 1911-1920, and so on, until the student completed all portions of the twentieth century included in the course. Each module after the initial module is named in the form mᵢⱼ, where i denotes the presentation difficulty and j denotes the lesson. In the example of FIG. 7, there are 5 lessons required to each be completed in order to complete the entire course, in which each lesson has from 3-5 difficulty positions.

Each lesson may have multiple variations, where the variations may be based on factors including but not limited to different levels of difficulty, somewhat similar to different sections of a high school class (honors, standard, remedial). In the example of FIG. 7, these different difficulties are depicted as different states along the vertical direction; for instance, the more difficult a lesson, the more advanced the concepts. The difficulty is a determined difficulty of completing the state as perceived by the instructor or author of the course book (referred to as the Integrated, Individualized Course, or MIIC). As i increases, the difficulty of completing the lesson increases. Note that when a student is in a particular state Sᵢⱼ, it may be possible to advance vertically is (e.g., to S_{i+1,j}) before moving to the next lesson; in this case, the author may prefer to view higher levels as “extra credit” rather than a more difficult version of the entire baseline. In general, a student may be placed in a less difficult section of the lesson for reasons such as but not limited to a lack of proficiency in a prerequisite of a portion of the lesson, a history of a lack of understanding of certain related concepts, performance in an earlier lesson, or the need to spend an atypically long amount of time in a related lesson.

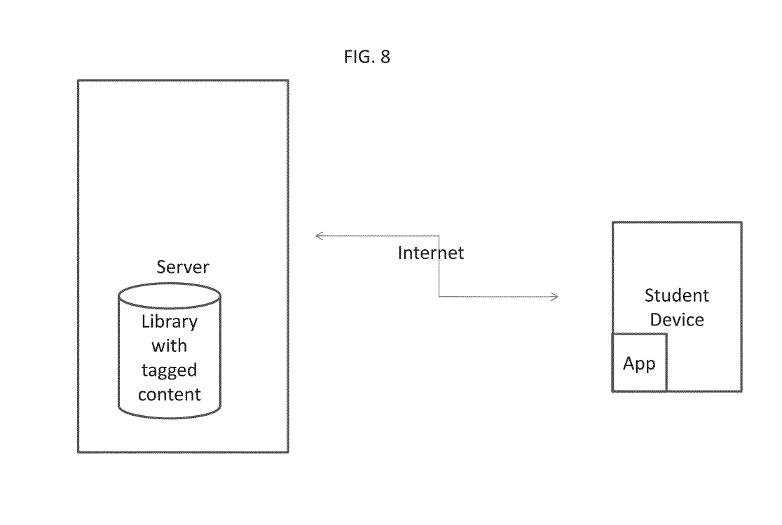

Each student carves out his/her own, unique learning path, where a learning path is the sequence of modules the student visits (we show two such paths in FIG. 7). As shown in FIG. 8, a student interacts with the system of the present invention typically using the Internet. The student uses a computing device, such as a computer, tablet, or mobile phone, which may have an App on board for interaction. Alternatively, the student device may use a browser or some other interface. Across the Internet, the system of the present invention includes a server, where the server includes or has connectivity to a library. In the preferred embodiment, the content stored in the library is tagged with identifying information as described herein.

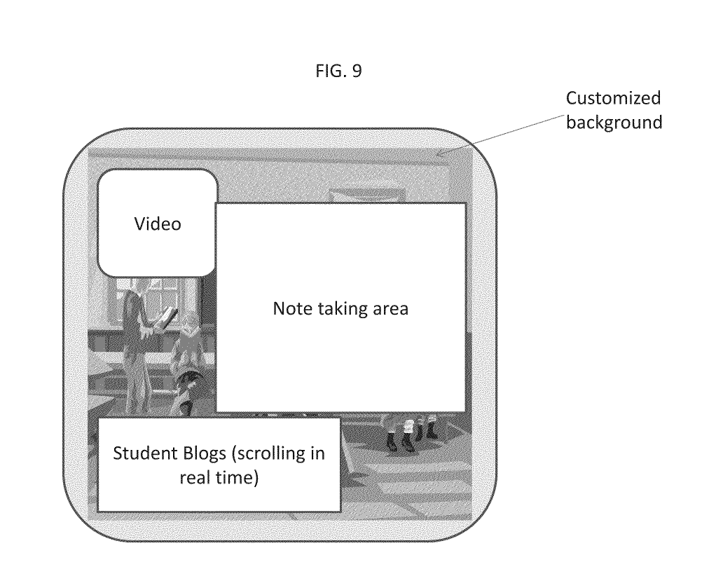

FIG. 9 depicts a typical display on a student device. As depicted herein (as one example) a student may have a customized background, which has been customized based on student, author, or teacher preference, and various “boxes” may also appear, such as a video of a lecture, an area for note taking, and real time blogging by students. The location of these items may be customizable by the student, teacher, or author as well.

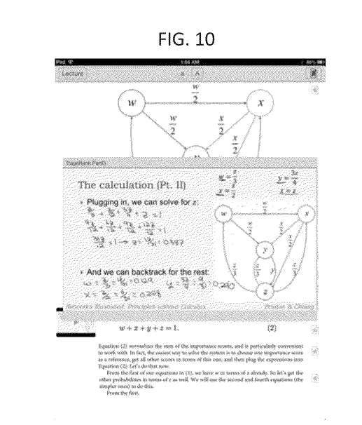

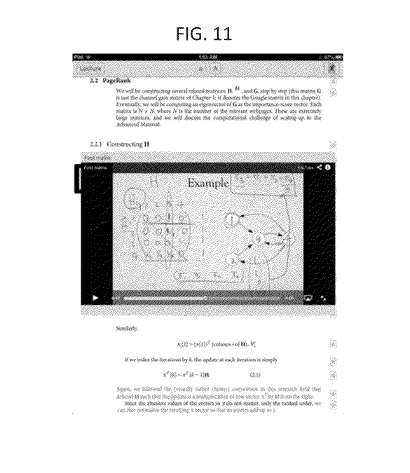

To start, two students can have different foundations for a particular course. For example, for a calculus course, one student may need to begin by being delivered a foundation in elementary Algebra (see FIG. 10), whereas another student may begin with Linear Algebra (see FIG. 11). This initial starting point, as well as the stages of progress, may be determinable based on student proficiency. The division of each course into modules is done in a logical fashion by the author, depending on the content of the course. In certain cases, it may be desirable to have multiple videos and cover multiple features in the same module; in this case, modules can be broken down further into segments. Each segment within a module may further include means for determining student proficiency for that segment.

Modules are comprised of a set of learning materials, such as but not limited to lecture videos, other videos, audio files, text, other pre-formatted content, animations, and social sharing features. Completing a module requires having viewed all requisite content in each lesson for that module as well as, potentially, demonstrating proficiency. Once a student completes a module, a decision must be made as to which module he/she will transition to next. In the end, the student may be given the option to choose, but the adaptation engine of the system of the present invention makes a recommendation.

This recommendation is based on a combination of (a) the possible next modules, as defined by the author, (b) the perceived performance of the student on each of the learning features in the recently completed module(s) as well as those that may be tested in the next module, where proficiency may be as perceived by the student and/or the system of the present invention, and (c) the thresholds to recommend transition into each of the possible next modules, also defined by the author.

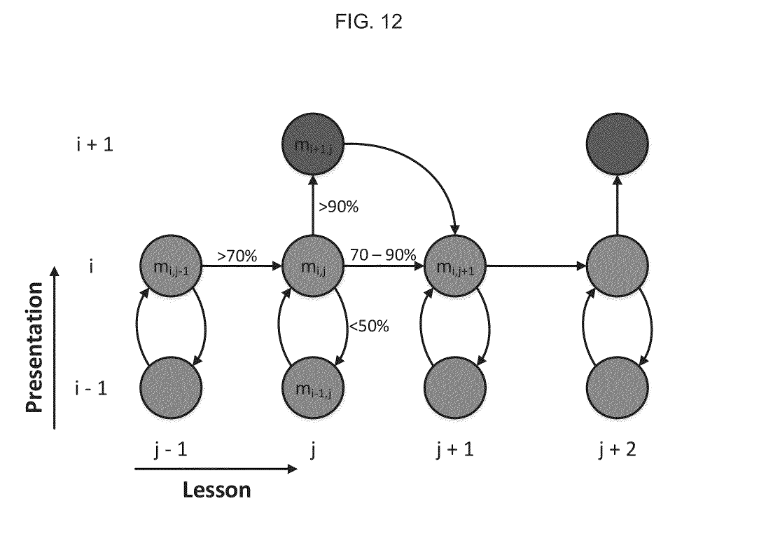

The author specifies transitions between modules through the authoring tool, in a manner similar to those of the example diagrammed in FIG. 12, which is a smaller transition diagram than shown in FIG. 7 to illustrate transitions more concretely. Importantly, note that each module can have a different number of outgoing links, and that these links are not bidirectional (e.g., if Module A can transition to Module B, that does not mean Module B can transition to Module A). Also, each lesson need not have the same number of modules. All of these factors—the number of modules and connectivity of the diagram—are fully specified by the author.

As before, moving horizontally progresses the student in the course, such as how a student would progress to one lecture from the previous lecture in a traditional course. Here, moving vertically changes the presentation of the content, perhaps in terms of quantity of content, or degree of difficulty (as in FIG. 7). The percentages shown are example intervals of demonstrated or determined performance of the student of the material in the module at the time the recommendation is made. Although exemplary percentages are shown, other percentages may be used, but importantly the movement from one module to another may be based on some threshold of proficiency. For example, if a student has just completed Module m_{i,j} and his/her aggregate performance is determined to be greater than 90%, then the system of the present invention will recommend that the student advance to Module m_{j+1,j} (e.g., to be presented with more advanced material).

Note that these transition thresholds can be feature-specific. For instance, a course on Calculus may contain one feature on limits, another on derivatives, and another on integrals. The features may all be covered in the same module or in different modules. But, for example, if the material in the next section was on derivatives, then the thresholds could be defined based on the student's performance on derivatives and/or some combination of the other three features. These different topical areas could be separately tagged by the author as distinguishable features. The author has the leisure to go as in depth with feature tagging as he/she desires; in the simplest case, a module or an entire course would consist of one feature only.

As noted, the system of the present invention includes the ability to determine student success in mastering the content. Student performance is determinable on a feature-by-feature basis, using as much data as the backend of the present invention has access to. There are three types of input: (1) individual performance, such as scores on multiple-choice assessments, (2) student behavior in watching and executing lessons, including but not limited to video-watching and text-reading behavior, and (3) demographic comparisons, such as including user-to-user similarity. Each of these may be factored in to reduce the prediction's noise as much as possible.

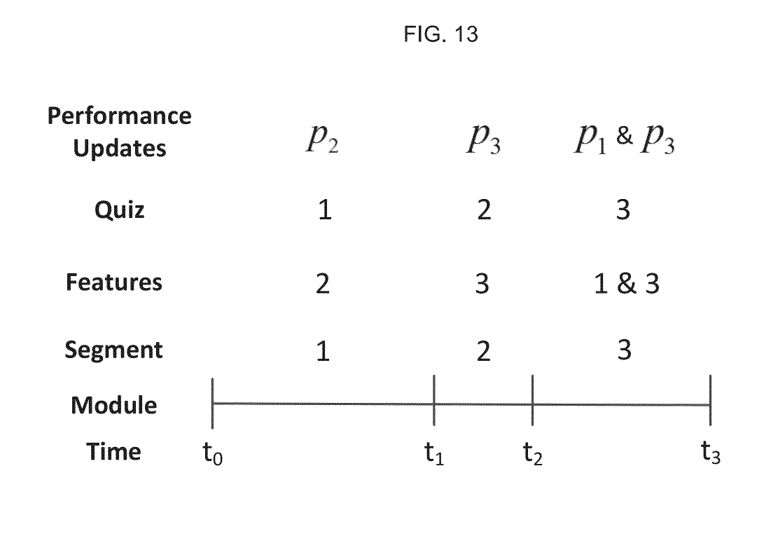

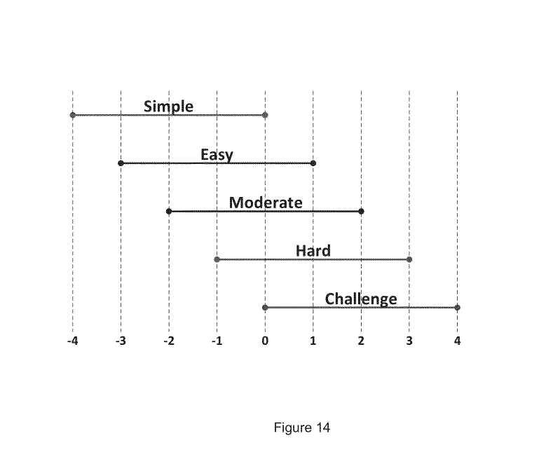

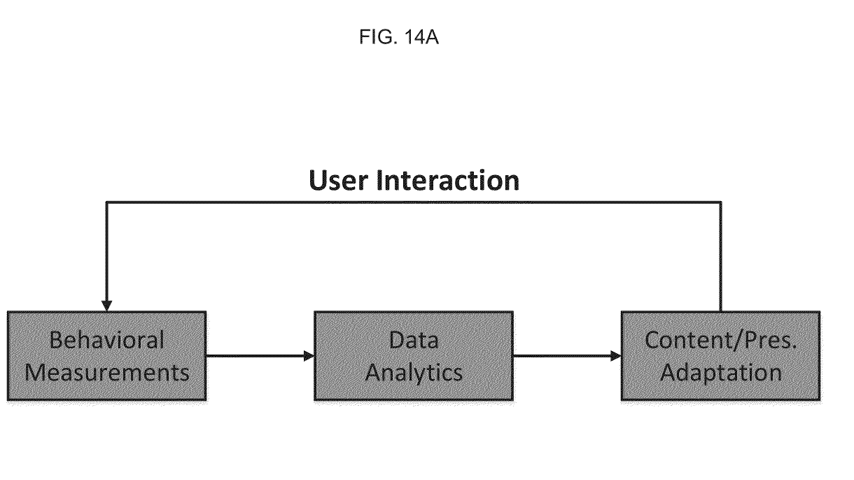

Each module may be sub-divided into a number of segments, which are the smallest building-blocks of the content; in the simplest case, each module would have only one segment. For purposes of data analytics, the author must tag each segment with the learning features that correspond to it. For example, in FIG. 13 a module is divided into three segments (1, 2, and 3), and the features contained in each segment are indicated. At the end of each module, the student has the option to complete a series of assessments, one per segment. In the preferred embodiment, an assessment is comprised of a series of questions and, more specifically, multiple choice questions. The student is not required, but recommended, to complete the questions. For each multiple choice question, the answer choices have different point-values associated with them. While the range of point-values may stay the same from question to question, the center-point can change depending on how difficult or easy the question is, as shown in FIG. 14.

Each question tests content explained in the module corresponding to one or more learning features of the specific segment. Hence, performance will vary on a feature-by-feature basis. The profiling algorithm also leverages the behavior data that the system gathers on how long each user spends on each segment—both the video and textual portions of the material. One can imagine four different types of students: those who spend a long time with the segment to really understand it; those who spend a long time with the segment and still struggle with it; those who spend a short time with the segment because they already understand it; and those who spend a short time with the segment because they are not interested in it. Clearly, the assessment score will change accordingly, but first a determination must be made as to which group the student falls into. That assessment may also vary feature-by-feature; for example one student may struggle with math but breeze through the concepts. As a result, a correlation is made between user behavior on each segment and the performance on the assessment, using each segment for which the user has taken the assessment. Using this correlation the system of the present invention is able to change the performance on a given feature proportional to the time spent watching and reading the segments on that feature, where the proportionality is dictated by the strength of the correlation.

As a third method of adjusting performance, the invention uses collaborative filtering by analyzing user-to-user similarities. At the end of each module, the current performance is augmented by the assessment score (which may or may not be present), the view-watching behavior correlation, and the score of similar students on the same assessment (which may or may not be present).

Each different state in a particular column may have different determinants for proficiency.

Components of Individualization

This discussion concerning FIGS. 12-14A describes the process of individualization in the present invention, which guides the user through a learning path. The preferred embodiment of individualization consists of three components, as shown in FIG. 14A: Behavioral Measurements, Data Analytics, and Content/Presentation Adaptation. Each of these has been alluded to previously, but can be formally described as follows.

Behavioral Measurements

The Behavioral Measurements component includes measurements of user behavior while interacting with the course material. In the current embodiment, the following usage data is collected:
A users grade on each question he/she chose to answer.
A user's current position in a video, which is obtained through fine-granular sampling and is used to completely reconstruct his/her viewing trajectory.
The amount of time a user spends on textual content or images, as well as which phrases he/she is highlighting or searching, is used to determine his/her reading behavior, and the reading behavior is used to subsequently adjust content delivery.
The social networking and note-sharing relationships between users, which is used to construct the social graph of the course.

Collection of this information is only made possible through the integration of the entire course delivery experience into a single mobile app. These measurements empower performance analytics that are necessary for adaptation.

Data Analytics

In the current embodiment, the Data Analytics component uses machine-learning techniques to generate and dynamically update a low-dimensional model for the high-dimensional process of student learning. This latent space can be either (a) pre-defined in terms of a variety of author-specified learning features, in which the content author has leeway in deciding the designation and will label the content accordingly by tagging through the authoring tool, or (b) determined automatically using factorization methods, in which the underlying artificial intelligence engine extracts content-concept relations through one of a number of methods, including (i) using text or audio processing methods to determine key terms which are thereby translated to concepts, or (ii) monitoring student behavior while interacting with the material. For case (a), here are a few examples:
Features can be topics in a course. These can be very general (e.g., “mathematical”, “conceptual”), or more specific (e.g., “power rule of differentiation”, “factoring a polynomial”), and even down to the atomic level.
Features can be learning styles. For instance, features could be a subset of: sensory—intuitive, visual—auditory, inductive—deductive, active—reflective, and sequential-global, such as described in Felder and Silverman's well-cited Learning and Teaching Style Dimensions.

Feature-granular performance is computed through machine learning techniques, using the following inputs and/or methods:
The user's learning analytics history from taking prior MIICs or a diagnostic exam.
The user's social graph, constructed by extracting the social network that includes all course users and links between them.
The performance on assessments related to the feature,
Correlation between assessment performance and video-watching behavior for the feature.
Relations between assessment performance and the frequency and/or depth of discussion the user has on the feature.
Collaborative filtering and content-based prediction, applied to user-quiz performance information, to extract user-user and quiz-quiz similarities and make predictions on unknowns (for instance, if a user did not take a particular quiz).
Low-dimensional factorization, which determines an abstract feature set that generates the most variation in student performance. In the case of manual labeling, these can be mapped to the author specifications to provide further input.

Content/Presentation Adaptation

Subsequently, the user's updated profile must be mapped to the content unit that will be presented next. The author will specify the possible transitions from each learning unit, which includes interval levels on the profiled performance. This boils down logically to a decision tree: the engine determines which interval the performance lies in, and based on the previous learning unit, the next is fully specified.

In the present invention, content can be adapted in various forms for a given user, to fit his/her learning desires and/or needs. This includes, but is not limited to, the following:
Switching paths. When the artificial intelligence detects that another learning path is likely a better fit for the student, the content—including videos, text, assessments, and notes—displayed in the next segment will be entirely different from that which would have been displayed on the original path.
Collapsing/expanding. Within a given segment of material, certain content can be collapsed or expanded depending on the student's current learning profile. For struggling students this can be useful to elaborate on explanation details/revision and hide advanced material. For advanced students, elaborate explanations can be hidden, and advanced material covered more thoroughly.
Replacing. Specific pieces of content—videos, sections, paragraphs, subsections, and so on—can be automatically replaced with others depending on the user's learning profile. For instance, one video may explain a concept in more detail than another and a user can be shown the one better suited for him/her. This is only made possible through a fast and efficient content modification engine.
Emphasizing. Content pertaining to learning features that a user possesses strengths/weaknesses in can be emphasized. For text, this can include modifying the font/color or highlighting, and portions of images/videos can be drawn to focus as well. This helps a student to quickly focus on these areas for reinforcement or improvement.

Social Media

This section describes how notes in an interactive e-book or other systems showing text can be shared with friends and contacts which are automatically determined with the help of Facebook and/or other social networks (“SNs”). The goal is to make it possible that only contacts/friends of the creator of the note can see the content while using the same application/product. These methods can also be used to construct the social graph of each course, which can be applied to data analytics as described previously.

In the next parts Facebook stands for all kind of social networks where people can connect: Facebook, LinkedIn, Twitter, Google+, etc. Friends describes friends, contacts or people the user is following (Twitter).

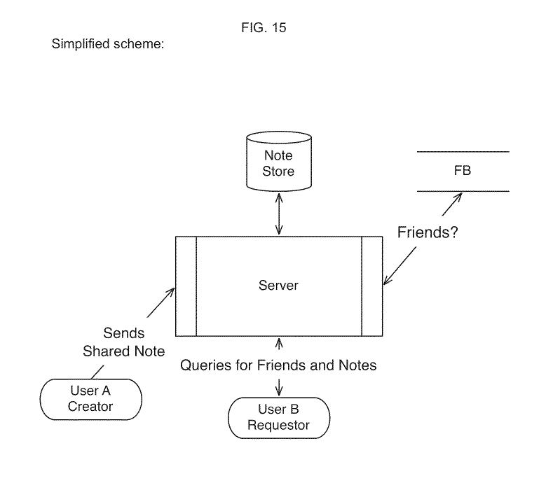

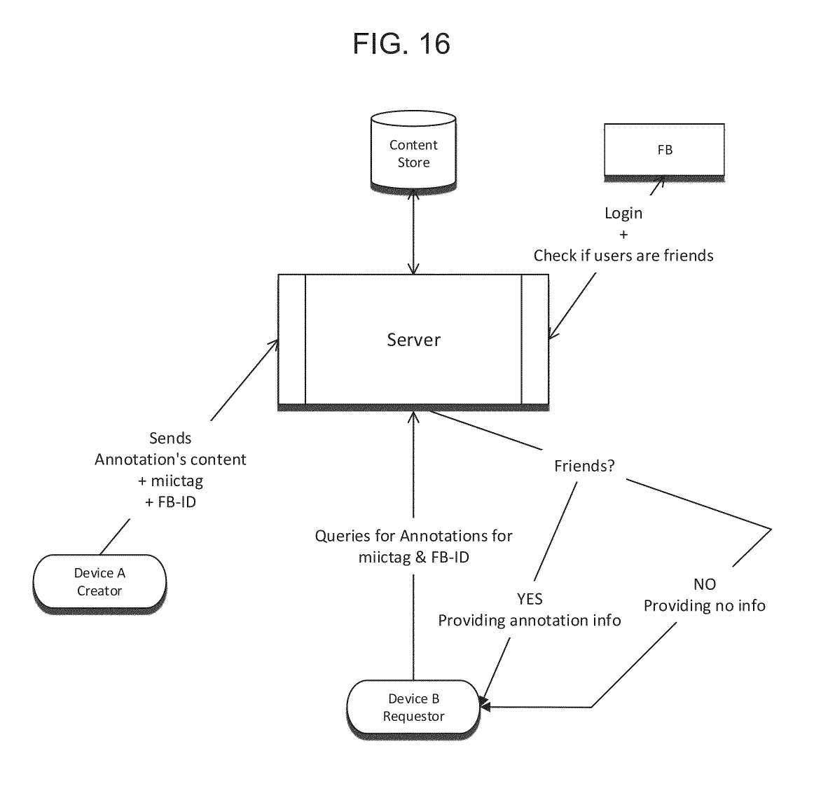

FIGS. 15 and 16 depict flow charts of social media uses. In a first step, a user logs into one or more SNs and authorizes our server to connect with his information on Facebook. This enables the server to obtain the user's friends tree and associations with other SN users with whom he or she is in contact (friends).

When the user creates a note and activates it for social sharing, the note is sent to a server of the present invention and it is stored as a shared note. It may be scanned for content and tagged.

Now, assume that one of this user's friends is also using a same MIIC of the present invention. When the friend goes to a page in the text, the application queries the server to see if there are any notes available. The server checks if a note-creator is connected to this friend. If he is, the friend's device will be provided with the note and the friend can now view it.

For this system to work, every note has to be associated to a user and his SN account. Also, it can be imagined that the creator of a note can select individual friends from a list to share the note with.

Notes can include text, images or drawings (for example drawings drawn by finger). The notes are stored on a server. Social Networks are only used to identify friends and contacts and the connections thereof.

It will thus be seen that the objects set forth above, among those made apparent from the preceding description, are efficiently attained and since certain changes may be made in carrying out the above process, in the described system, and in the construction set forth without departing from the spirit and scope of the invention, it is intended that all matter contained in the above description and shown in the accompanying drawings shall be interpreted as illustrated and not in a limiting sense.

It is also to be understood that the following claims are intended to cover all of the generic and specific features of the invention herein described, and all statements of is the scope of the invention which, as a matter of language, might be said to fall therebetween.

1. Using a computing system with communication access to a plurality of computing devices and structuable memory, a method for sequentially delivering course content to a student based on the student's capabilities, comprising the steps of:
forming a library,
delivering content taken from said library,
tracking student usage,
determining student proficiency, and
determining the next module for delivery based on student usage and proficiency.

2. The method of claim 1, wherein said content in said library includes multiple elements, and each element is tagged with identifying information.

3. The method of claim 2, wherein said library further includes a database indexed by said identifying information.

4. The method of claim 1, wherein said library is updated through content uploaded via the internet and social media.

5. The method of claim 1, wherein said content includes video.

6. The method of claim 1, wherein the delivery of content is customized for a recipient, wherein the customization is based on behavioral measurements associated with the recipient's interactions with the computing device, a model of the recipient's performance, and on performance analytics.

7. The method of claim 1, wherein the form of presentation of said content to a student is based in part on receiver-selected preferences, wherein said preferences are identified in part by said student.

8. A system for delivering a sequence of lessons to a student comprising:
a library, said library being formed with content identified by type and keyword,
a server for operating an algorithm in which a determination is made as to which content to deliver to the student, said determination based on student usage and proficiency, and
a computing device including an interface for student viewing;
wherein content from said library is displayed using said interface and the content and its presentation are selected by said server based on operation of said algorithm.

9. The system of claim 8, wherein said interface is in the form of an application resident on said computing device and includes a graphical user interface.

10. The method of claim 8, wherein said content in said library includes multiple elements, and each element is tagged with identifying information.

11. The system of claim 8, wherein said library further includes a database indexed by said identifying information.

12. The system of claim 8, wherein said library is updated through content uploaded via the internet and social media.

13. The system of claim 8, wherein said content includes video.

14. The system of claim 8, wherein said content is chosen in part based on student proficiency determination, and said proficiency is determined based at least in part on an interactive session between a student and said server.

15. The system of claim 8, wherein the form of presentation of said content to a student is based in part on receiver-selected preferences, wherein said preferences are identified in part by said student.

16. A method for a computing system, said system including structurable memory storage and a processor, to determine course progression for a student comprising the steps of:
forming a library of content items, each of said items identified by a unique identifier,
forming aggregations of said items, said aggregations determined based on topic and level of difficulty,
creating a mapping between said aggregations, said mapping based on topical progression and degree of difficulty,
delivering one of said aggregations for presentation to a student,
assessing said student's performance of learning the content in the delivered aggregation to as to determine an assessment, and
using said assessment together with any prior assessments to determine the next aggregation to deliver to said student.

17. The method of claim 16, wherein said library further includes a database indexed by said identifying information.

18. The method of claim 16, wherein said library is updated through content uploaded via the internet and social media.

19. The method of claim 16, wherein the delivery of content is customized for a recipient, wherein the customization is based on behavioral measurements associated with the recipient's interactions with the computing device, a model of the recipient's performance, and on performance analytics.

20. The method of claim 16, wherein the form of presentation of said content to a student is based in part on receiver-selected preferences, wherein said preferences are identified in part by said student.
